(19) United States
(12) Patent Application Publication
(10) Pub. No.: US 2004/0067327 A1
(43) Pub. Date: Apr. 8, 2004

(54) Method of joining plastic sheet materials

(76) Inventor: Gordon Cook, Hampshire (GB)

Correspondence Address: BAKER & BOTTS, 30 ROCKEFELLER PLAZA, NEW YORK, NY, 10112

(21) Appl. No.: 10/432,523

(22) PCT Filed: Nov. 20, 2001
(86) PCT No.: PCT/GB01/05112

(30) Foreign Application Priority Data
Nov. 25, 2000 (GB) 0028780.5

(51) Int. Cl. F16L 1/00

(52) U.S. Cl. 428/34.1; 428/61; 428/57

(57) ABSTRACT

A method of joining thin plastics film or sheet materials to form sealed pressure vessels or containers particularly vessels or containers for use in the medical industry such as blood or urine bags. Experience has shown that there is a wide distribution of working life to failure for commonly used bladder materials due to fatigue stress to the area adjacent to the weld joining the sheet materials together resulting from radio frequency welding which is a common prior technique. In the present invention an more accurate controllable and repeatable method using is disclosed using the plastics injection moulding technique which uprates below the melting points of the materials to be joined thus avoiding early failure due to material degradation caused by the radio frequency welding.

### FIELD OF THE INVENTION

The present invention relates to a method of joining thin plastics film or sheet materials to form sealed pressure vessels or containers particularly vessels or containers for use in the medical industry such as blood or urine bags.

### BACKGROUND OF THE INVENTION

A conventional method employed in the construction of sealed pressure vessels or containers is to bond sheets of plastics material together to form the vessel or container using radio frequency (RF) welding. In this technique high frequency current is passed through the plastics material, which acts as a dielectric, held between a pair of radio frequency electrodes. The heat generated by this process is sufficient to melt the material being bonded to cause fusion between adjoining plastics sheets. A mechanical press is used to apply pressure to the fusion zone to complete the weld.

A problem which is experienced with radio frequency welding is the uncertainty of the bond quality and in particular the strength of the material in the heat affected zone around the weld.

In many medical applications this is of no significant consequence since the vessel or container formed may be used only once during a prescribed operating life.

There are other instances however where the integrity of the vessel or container to be formed is crucial over an extended period of continuous use.

This is a particularly important requirement for the inflatable bladder of the A-V Impulse System™ a device widely used in the medical field to enhance blood circulation in the human body.

This device operates by pumping the bladder, when held against a bodily extremity such as the plantar arch of the foot, with pressurised air at a pre-determined cyclical frequency. Patient treatment may continue at this cyclical rate for many days during which it is important that there must be no failure of the weld between the plastics skins forming the bladder or the surrounding area.

Experience has shown that there is a wide distribution of working life to failure for commonly used bladder materials due to fatigue stress of the area adjacent to the weld resulting from radio frequency welding.

Whereas it might be considered appropriate to overcome the problem by simply increasing the thickness of the bladder material this leads in practise to many disadvantages. Thus as thickness of the material is increased so does its stiffness and hence compliance between the bladder and the bodily part to which it is applied is compromised whilst in addition the bladder is more difficult to inflate resulting in a loss of impulse energy. Furthermore by increasing the working life of the bladder in this way encourages re-use between patients that can lead to cross contamination infection.

### SUMMARY OF THE INVENTION

It is an object of the present invention to provide a method of joining sheets of thin plastics materials together in a more accurate controllable and repeatable manner using a plastics injection moulding technique which operates below the melting point of the materials to be joined thus avoiding early failure due to material degradation caused by the prior art radio frequency welding technique in the area of the joint.

According to one aspect of the invention there is provided a method of joining two sheets of plastics material comprising holding peripheral edge portions of the sheets together in overlapping relationship, and moulding a bead of elastomeric material around the peripheral edges of the sheets to adhere to the material of the sheets to form a sealed joint.

Advantageously the bead is formed by injection moulding in a mould cavity, and wherein the temperature of the injection moulding is carried out at a temperature below the melting point of the plastics material of the sheets. In this way degradation of the base plastics material as occurs with radio frequency welding, is avoided.

According to a further aspect of the invention as provided a pressure vessel comprising first and second exterior plastics skins connected together along a sealed joint, the sealed joint being formed of a bead of elastomeric material moulded over the. peripheral edges of the skins forming the line of the sealed joint.

Other features and advantages of the invention will now be described with reference to the accompanying drawings.

### BRIEF DESCRIPTION OF THE DRAWINGS

In the accompanying drawings:

FIGS. 1(a), (b) and (c) show respectively a plan view, side view and a wall cross sectional detail view along A-A of FIG. 1(a) illustrating the radio frequency welding technique for forming welded joints between thin sheet plastics materials to form an inflatable bladder in accordance with the prior art,

FIGS. 2(a), (b) and (c) show respectively a plan view, cross sectional view along A-A of FIG. 2(a) and side elevational view illustrating a method for joining two sheets of a plastics material together to form an inflatable bladder in accordance with the invention,

FIGS. 3(a) and 3(b) illustrate an attribute of the invention as described with reference to FIG. 2 in accordance with an embodiment of the invention,

FIG. 4 illustrates a modified technique for forming the over moulding closure bead of the welding technique in accordance with the invention,

FIG. 5(a) and (b) show respectively a radio frequency welded joint in accordance with the prior art and a joint formed in accordance with the present invention illustrating an advantage of the latter over the former, and

FIG. 6 illustrates a representative manufacturing process for constructing an inflatable bladder or other pressure vessel using the technique in accordance with the present invention.

### BEST MODES OF CARRYING OUT THE INVENTION

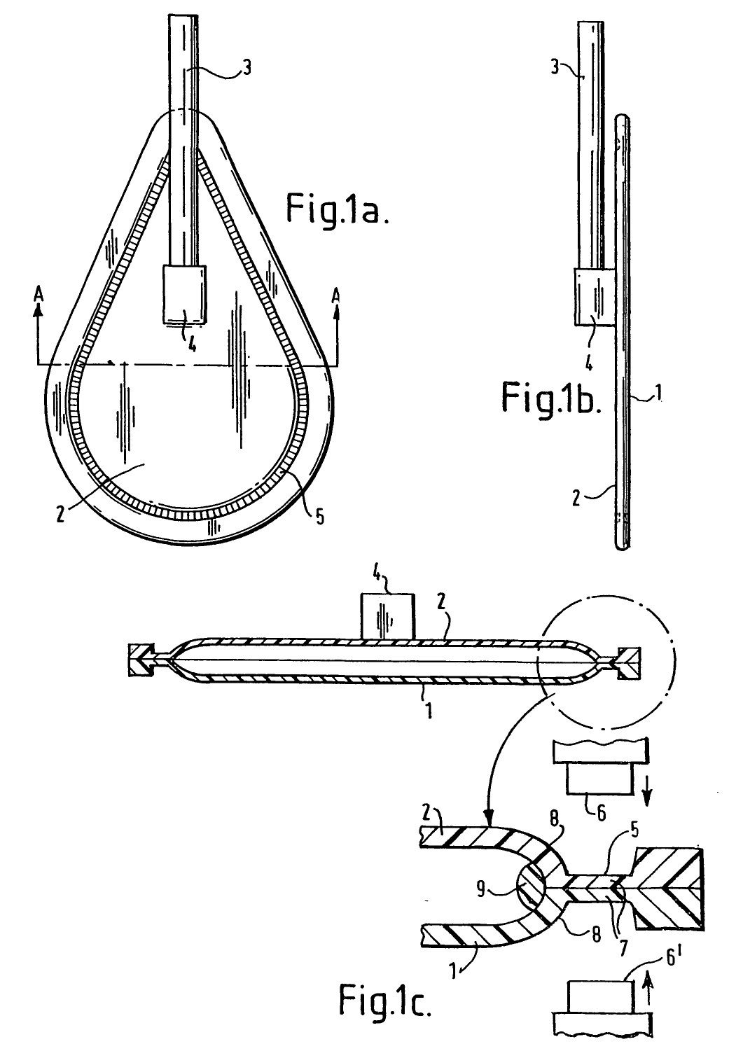

With reference to the drawings FIG. 1 illustrates the conventional method of forming an inflatable bladder for the A-V Impulse System™ using radio frequency welding.

The bladder shown in FIG. 1 comprises two flexible plastics sheets 1 and 2 of ovoid form welded together along their overlapping outer edge portions by radio frequency welding. The bladder is provided with an inlet tube 3 for pressurised air connected to a moulded inlet boss 4 formed on the skin 2.

The thickness of the bladder skins used in the example shown is 0.25 mm. With edge portions of the skin 1 and 2 held in overlapping relationship as shown a radio frequency weld is applied to zone 5 at a spacing from the outer peripheral edges of the skins 1 and 2 by bringing together electrodes 6, 6′ to form a reduced thickness cross section at 7 typically 50%-70% of the original thickness.

The consequence of welding is the necking down of the material directly adjacent to the weld area on both materials at 8 and an extruded bead 9 of molten polymer formed between the skins 1 and 2 as shown.

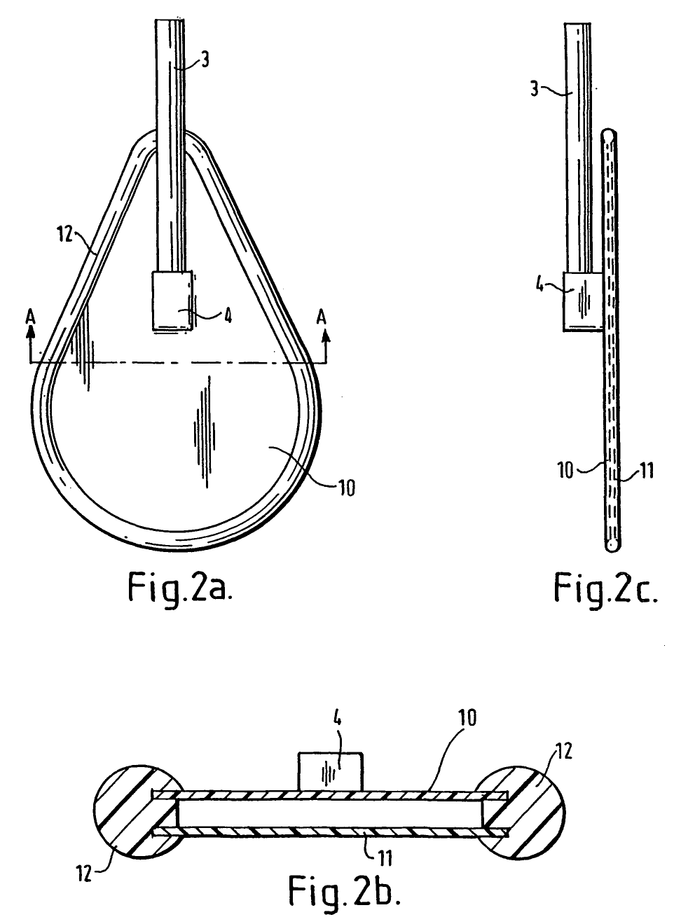

The novel technique in accordance with the invention used to form the inflatable bladder is quite different from the radio frequency welding process and is illustrated in FIGS. 2 through 6.

In FIG. 2 the inflatable bladder again in the form of an ovoid, is constructed from two flexible plastics sheets or skins 10 and 11. In this process in contrast to the radio frequency welding technique, the skins 10 and 11 are joined only at their outer peripheral edges as by means of an overmoulded bead 12 of an elastomeric material which is chosen preferentially to adhere to the skin material 10, 11 at an acceptably low process temperature that will not distort, compromise or otherwise degrade the performance of the bladder materials resulting in early fatigue and failure.

A suitable combination of materials for the bladder skins 10 and 11 and the closure bead 12 are those which are polypropylene based. Thus the skins 10 and 11 of the bladder may be polyolefine films and the overmoulded bead 12 used to form the bond being a thermoplastic elastomer selected for optimum chemical affinity with the polyolefine.

For additional film strength and to provide patient comfort the outer surface of the inflatable bladder may be laminated to a non-woven material such as a porous polyester.

As mentioned earlier this novel technique of bonding plastics materials together has many advantages over conventional radio frequency welding.

Thus as will be apparent from FIG. 2 the thickness of the skins 10 and 11 of the bladder remains substantially constant both beyond and over the joint area and remains consistent from product to product. As a result there is no reduction in strength or fatigue life compared with joints produced by the radio frequency welding technique which as will be apparent from the explanation given with reference to FIG. 1, inherently results in deformation of the skin material when in the molten state and under pressure, giving rise to a reduction in crosssectional thickness.

Furthermore there is no abrupt step change in the cross-section of the joint that may be liable to abnormal stressing.

The joint shown in FIG. 2 is produced at a temperature below the melting point of the material of the bladder skins 10 and 11 so that the inherent properties of that base material are substantially unaffected. In comparison with radio frequency welding where the material is raised to melting temperature and beyond, the chemical structure of the skin material may be altered for example by eliminating the plasticised oil contained within the polymer leading to embrittlement and early fatigue as referred to earlier.

The joint shown in FIG. 2 has the benefit that as a result of the careful design of the profile of the overmoulding bead 12 the stress from the skins 10 and 11 under load passes progressively into the bead 12 by a tapered strain relief section rather than an abrupt sectional change.

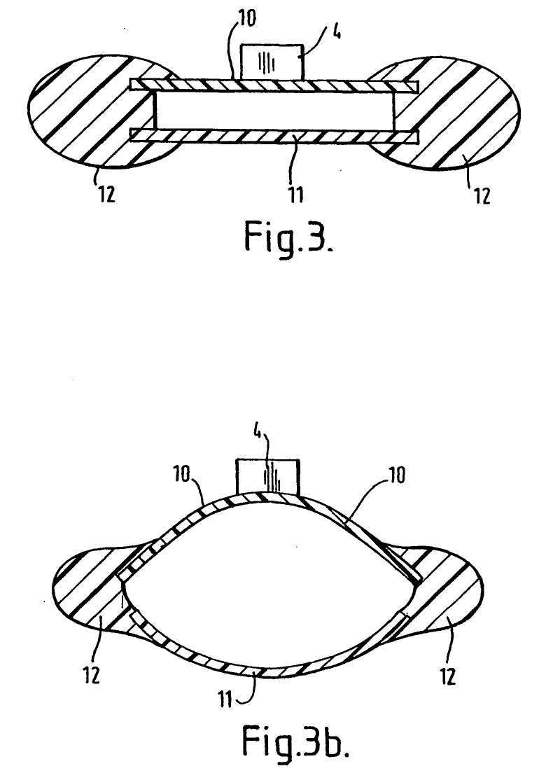

As a further illustration of the advantages of the technique in accordance with the invention, the overmoulding bead 12 may be designed to maximise inflation of the bladder and separation of the bladder skins 10 and 11 during inflation. Thus the overmoulding bead 12 may be formed at the joint such that the loading of the bladder under inflation is applied as a peel force into the bead 12 to be dissipated by a hinging action within the bead 12 itself as illustrated in FIGS. 3(a) and 3(b) showing respectively how the bead 12 adapts itself to the stretching which takes place when the bladder is inflated see FIG. 3(b).

Thus as the material used to form the overmoulding bead 12 is relatively elastic a proportion of the stress and shock resulting from rapid inflation is absorbed by limited extension of the joint itself.

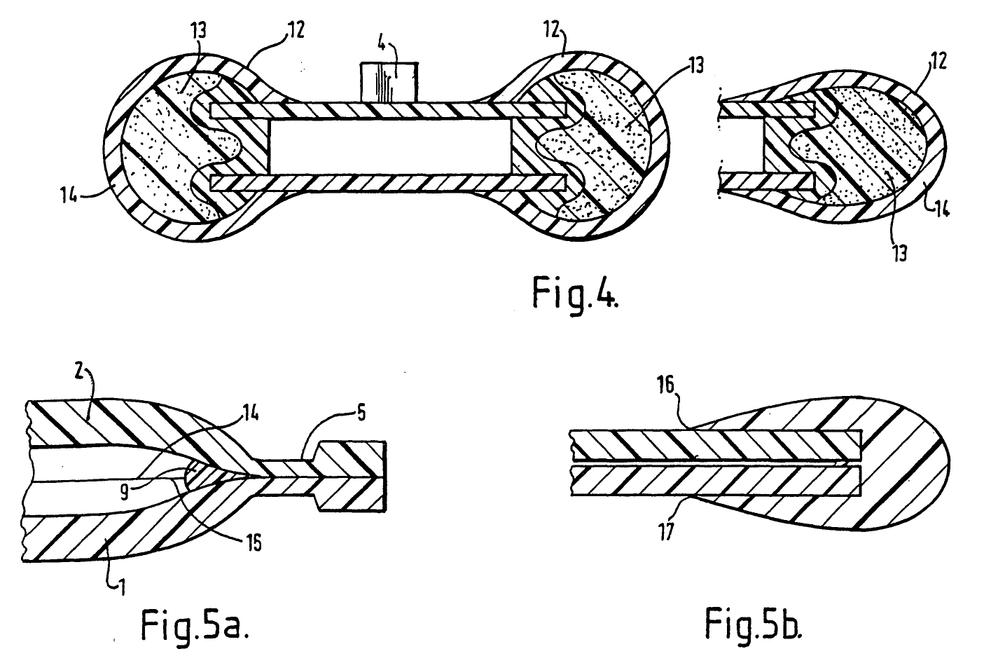

The cross section of the overmoulded bead 12 may be proportioned to maximise inherent strength and bond strength whilst being sufficiently inconspicuous for acceptable patient compliance for example when fitted to the foot. A further benefit to aid patient compliance is to modify the cross section of the bead 12 to that of a closed cell foam structure 13 internally, contained within a skinned surface 14 of consistent density as depicted in FIG. 4.

The joint illustrated in FIG. 2 provides a long leak path as shown in FIG. 5, against discharge of a fluid contained within the bladder to atmosphere or the surrounding environment.

Whereas in conventional radio frequency welding the leak path may be as direct as through the thin base material thickness 14, 15 adjacent to the weld as shown in FIG. 5(a), the leak path in the overmoulded design in accordance with the invention as shown in FIG. 5(b), is via two engaged surfaces 16, 17 and one substantially base material thickness.

One advantage of the overmoulded joint in accordance with the invention is that leakage due to fatigue failure is far less liable to occur whilst leakage due to an adhesive bond, as opposed to a cohesive bond, that subsequently delaminates in use is not possible as no such opportunity for failure can occur due to the bead design.

A further advantage of the overmoulded joint in accordance with the invention is that the peripheral edge of the joint is sealed so that both the irritation or inconvenience of a diecut separated edge is avoided as is the possibility that dirt or contamination can be harboured between separable layers.

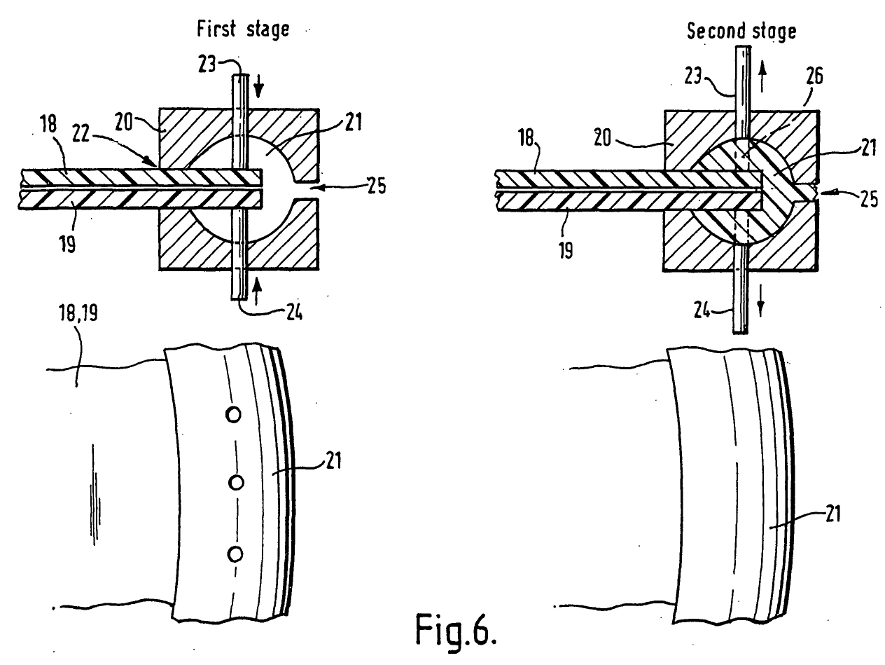

A representative manufacturing process to produce an inflatable bladder or other pressure vessel or container using the over moulded bead technique in accordance with the invention is illustrated in FIG. 6.

The skin walls 18, 19 of the vessel to be formed are loaded into a plastics injection mould tool 20 with a cavity 21 suitably proportioned to form the overmoulding bead.

The mould tool 20 is dimensioned to apply sufficient pressure at point 22 to prevent high pressure molten thermoplastics elastomer flowing out of the tool 20 and consequently over or between the skins 18, 19 when the tool 21 is clamped shut in the position shown.

Retractable core pins 23, 24 are positioned within the mould cavity 21 at suitable spacings to hold the unsupported ends of the skins 18 and 19 during the first stage of the overmoulding process.

When the tool 20 is shut and the retractable core pins 23, 24 set inwards in their fully forwards positions, molten elastomer is injected through the gate 25. At a pre-determined stage during the injection cycle as the elastomer begins to freeze the retractable core pins 23, 24 are withdrawn and the injection process continued until the cavities 26 left by the pins 23, 24 are finally filled.

The invention is described with reference to the formation of an inflatable bladder for the A-V Impulse System™ but it will be readily appreciated to those skilled in the art that the invention has much wider application to the construction of other pressure vessels or containers not necessarily for the medical field and indeed in any situation which requires that sheets of plastics materials are attached to one another to form a sealed joint.

1. A method of joining two sheets of plastics material comprising holding peripheral edge portions of the sheets together in overlapping relationship, and moulding a bead of elastomeric material around the peripheral edges of the sheets to adhere to the material of the sheets to form a sealed joint.

2. A method as claimed in claim 1 wherein the bead is formed by injection moulding in a mould cavity, the temperature of the injection moulding being carried out at a temperature below the melting point of the plastics material of the sheets.

3. A method as claimed in claim 2 wherein the peripheral edges of the sheets are held together in the mould cavity by means of retractable pins.

4. A method as claimed in claim 3 wherein the retractable pins are withdrawn after formation of the bead, the injection moulding process continuing until the spaces previously occupied by the retractable pins are filled with molten elastomeric material.

5. A method as claimed in any preceding claim wherein the plastics material is a polyolefin film material and the injection material a thermoplastic elastomer selected for optimum chemical affinity with the polyolefin film.

6. A pressure vessel comprising first and second exterior plastics skins connected together along a sealed joint, the sealed joint being formed of a bead of elastomeric material moulded over the peripheral edges of the skins forming the line of the sealed joint.

7. A pressure vessel as claimed in claim 6 including an inlet conduit moulded to the first or second skin for admission of pressurised air to the interior of the vessel thereby to inflate the vessel.
